(19) United States
(12) Patent Application Publication
(10) Pub. No.: US 2015/0090225 A1
(43) Pub. Date: Apr. 2, 2015

(54) FUEL INJECTION VALVE AND FUEL INJECTION DEVICE WITH SAME

(71) Applicant: Tatsuo Kobayashi, Susono-shi (JP)

(72) Inventor: Tatsuo Kobayashi, Susono-shi (JP)

(73) Assignee: TOYOTA JIDOSHA KABUSHIKI KAISHA, Toyota-shi, Aichi-ken (JP)

(21) Appl. No.: 14/394,555

(22) PCT Filed: May 11, 2012
(86) PCT No.: PCT/JP2012/062208

§ 371 Date: Oct. 15, 2014

(51) Int. Cl. F02M 63/00; F02D 41/30

(52) U.S. Cl. CPC F02M 63/0036; F02D 41/30
USPC 123/445; 239/585.5

(57) ABSTRACT

A fuel injection valve includes: a needle valve including a seat portion in a front end side; a nozzle body including a seat surface on which the seat portion sits, and including an injection hole at a downstream side with respect to the seat surface; and an injection-hole extending member including: a pressure receiving portion that receives pressure in a combustion chamber of an engine; and a movable portion that moves in the injection hole in an axial direction of the injection hole in response to the pressure received by the pressure receiving portion, and that changes length of the injection hole.

### TECHNICAL FIELD

The present invention is related to a fuel injection valve and a fuel injection device with the same.

### BACKGROUND ART

Conventionally, there is known a fuel injection valve capable of changing a spray angle of injection fuel. It is desirable that the spray angle is suitably adjusted to avoid fuel adhesion to a wall of a combustion chamber or a piston top surface. For example, Patent Document 1 discloses a fuel injection device having a piezoelectric element arranged within an injection hole to adjust its diameter or length. The injection hole diameter or the injection hole length is adjusted, so the spray angle is adjusted. Also, Patent Document 2 discloses a fuel injection nozzle having a coaxial double needle to open and close a first injection hole and a second injection hole. The lifting amount of the coaxial double needle is changed to switch one-stage injection or two-stage injection, so that the spray angle can be changed.

### PRIOR ART DOCUMENT

### Patent Document

[Patent Document 1] Japanese Patent Application Publication No. 2001-220285

[Patent Document 2] Japanese Patent Application Publication No. 2009-275646

### SUMMARY OF THE INVENTION

### Problems to be Solved by the Invention

However, the fuel injection device disclosed in Patent Document 1 requires wiring or a drive device for applying voltage to the piezoelectric element, so that the system might be complicated. Also, there might occur a problem whether or not the piezoelectric element is suitably operated under high temperature environment. As for the fuel injection nozzle disclosed in Patent Document 2, the change in the spray angle leads to a change in the number of the injection holes, so that the fuel flow rate might be changed.

An object of the fuel injection valve and the fuel injection device with the same disclosed herein is to suitably change a spray angle.

### Means for Solving the Problems

To solve the above problem, a fuel injection valve disclosed herein includes: a needle valve including a seat portion in a front end side; a nozzle body including a seat surface on which the seat portion sits, and including an injection hole at a downstream side with respect to the seat surface; and an injection-hole extending member including: a pressure receiving portion that receives pressure in a combustion chamber of an engine; and a movable portion that moves in the injection hole in an axial direction of the injection hole in response to the pressure received by the pressure receiving portion, and that changes length of the injection hole.

In the fuel injection valve, when its injection hole length is long, the spray angle is small and the penetration is strong. For example, in a case of intake stroke injection, a piston is located near BDC (bottom dead center) at the time of the fuel injection. Thus, in order to evenly spread the spray in the combustion chamber, and to obtain a uniform fuel-air mixture, it is desirable to reduce the spray angle. On the other hand, in a case of compression stroke injection to form the stratified air-fuel mixture or to form diffusion combustion in a diesel engine, the piston is near TDC (top dead center) and is close to the fuel injection valve at the time of the fuel injection. Thus, in order not to adhere the liquid fuel to the piston, it is desirable that the spray angle is increased. Herein, when the compression stroke injection is performed, the pressure within the combustion chamber to which a front end portion of the fuel injection valve is exposed is increased. The pressure receiving portion receives the high pressure within the combustion chamber, so that the movable portion moves within the injection hole, and hence the injection hole is short. When the injection is short, the spray angle is increased. It is therefore possible to suppress the liquid fuel from being adhered to the piston.

The pressure receiving portion can form a gas chamber between the pressure receiving portion and a front end portion of the nozzle body. When the high pressure within the combustion chamber is higher than the pressure within the gas chamber, the pressure receiving portion can be warped to push the movable portion toward the upstream side of the injection hole. When the movable portion is pushed toward the upstream side of the injection hole, the injection hole length is short. When the pressure within the combustion chamber is lower, the gas within the gas chamber can return the pressure receiving portion and the movable portion to respective original positions.

The movable portion can have a tubular shape with an axis coinciding with the axial direction of the injection hole, and the pressure receiving portion can be a plate shaped body that extends radially outward from a front end of the movable portion in a direction, perpendicular to the axis of the injection hole, of the nozzle body, and that includes an outer circumferential edge portion supported by the nozzle body.

The outer circumferential edge of the plate shaped body is supported by the front end portion of the nozzle body, so that the pressure receiving portion can be warped with respect to the supporting portion as a fulcrum, and hence the movable portion having a tubular shape can slide on the inner circumferential surface of the injection hole.

A clearance is formed between an inner circumferential surface of the injection hole and an outer circumferential surface of the movable portion under atmospheric pressure. The clearance is permitted to be formed under atmospheric pressure, thereby facilitating the formation of the injection hole and the movable portion. On the other hand, when the fuel is actually injected, the pressure within the cylinder suppresses a stepped difference within the injection hole.

The fuel injection valve disclosed herein can include a projection portion provided in a continuous portion of the movable portion and the pressure receiving portion, and projects toward a piston provided in the engine. The continuous portion of the movable portion and the pressure receiving portion is located at an opening edge portion of the injection hole. If the opening edge of the injection hole has a smooth curved shape (R shape), the Coanda effect might cause the spray to extend along a lower surface of the pressure receiving portion, so that the fuel fluctuation might be increased in the outer circumferential portion of the spray. Therefore, the provision of the projection portion can suppress the Coanda effect to suppress the fuel fluctuation in the outer circumferential portion of the spray.

The fuel injection valve can include a swirl flow generating portion that causes fuel injected from the injection hole to swirl. The causing of the fuel to swirl generates an air column within the injection hole, thereby generating fine bubbles between the fuel and the air column. After the fine bubbles are injected from the injection hole, the bubbles are crushed to atomize the particle diameter of the fuel spray. Also, in the case of injecting the fuel including such fine bubbles, it is requested to suppress the adhesion of the liquid fuel to a wall of the combustion chamber and particularly to a top surface of the piston. It is therefore effective to provide the injection-hole extending member in the fuel injection valve having a swirl flow generating portion.

The injection-hole extending member provided in the fuel injection valve disclosed herein is movable. The actuation of the injection-hole extending member can remove deposits accumulated around the injection hole. Further, the fuel is injected with the injection-hole extending member actuated, so that the deposits can be effectively removed. Thus, the compression stroke injection is performed regularly and the injection-hole extending member is performed actively, thereby performing the deposit cleaning. Specifically, a fuel injection device can include: the fuel injection valve of any one of claims 1 to 5; and a controller controls a timing of fuel injection from the fuel injection valve, wherein the controller controls the fuel injection valve to perform compression stroke injection, when the compression stroke injection is not performed at a predetermined time for a predetermined period on a basis of a fuel injection history.

### Effects of the Invention

According to the fuel injection valve disclosed herein, it is possible to suitably change a spray angle.

### BRIEF DESCRIPTION OF THE DRAWINGS

FIG. 1 is an explanatory view of an example of an engine system equipped with a fuel injection device including a fuel injection valve according to a first embodiment;

FIG. 2 is an explanatory view illustrating a cross section of a main portion of the fuel injection valve in the first embodiment;

FIG. 3A is an explanatory view illustrating the state where an front end portion of the fuel injection valve is attached with an injection-hole extending member, and FIG. 3B is an explanatory view illustrating the front end portion of the fuel injection valve, according to the first embodiment, attached with the injection-hole extending member;

FIG. 4 is a perspective view of the injection-hole extending member;

FIG. 5 is an explanatory view illustrating the state where the fuel is injected and the injection hole length is short;

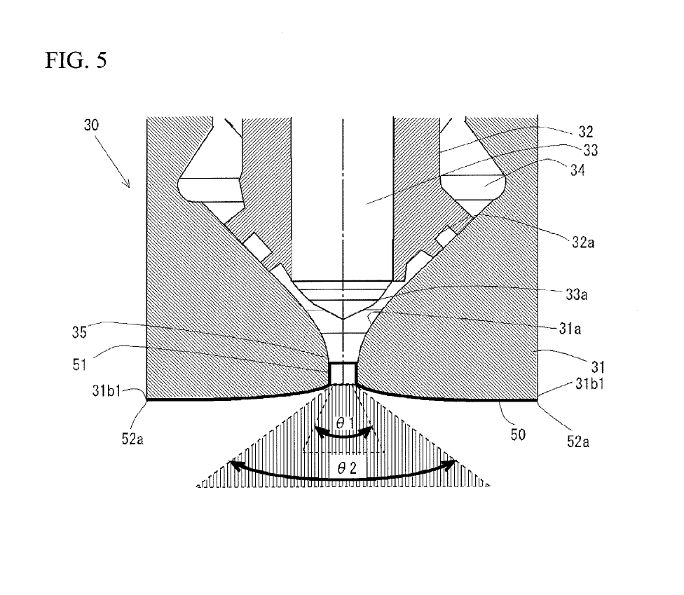

FIG. 6 is a graph schematically illustrating a correlation between injection hole length/injection hole diameter and a spray angle;

FIG. 7 is a flow diagram illustrating an example of control performed by the fuel injection device according to the first embodiment;

FIG. 8A is an explanatory view illustrating a front end portion of a fuel injection valve according to the second embodiment, and FIG. 8B is an explanatory view illustrating the state where an injection-hole extending member is moved and the injection hole length is short;

FIG. 9 is a cross section of the injection-hole extending member provided in the fuel injection valve according to the second embodiment;

FIG. 10 is an explanatory view illustrating a front end portion of a fuel injection valve according to a third embodiment; and

FIG. 11 is an explanatory view illustrating an example of a positional relationship between the fuel injection valve and a spark plug.

### MODES FOR CARRYING OUT THE INVENTION

Hereinafter, a description will be given of an embodiment of the present invention with reference to the drawings. It should be noted that a size and ratio of each portion do not correspond to the actual ones in some drawings. Also, a detail illustration is omitted in some drawings.

### First Embodiment

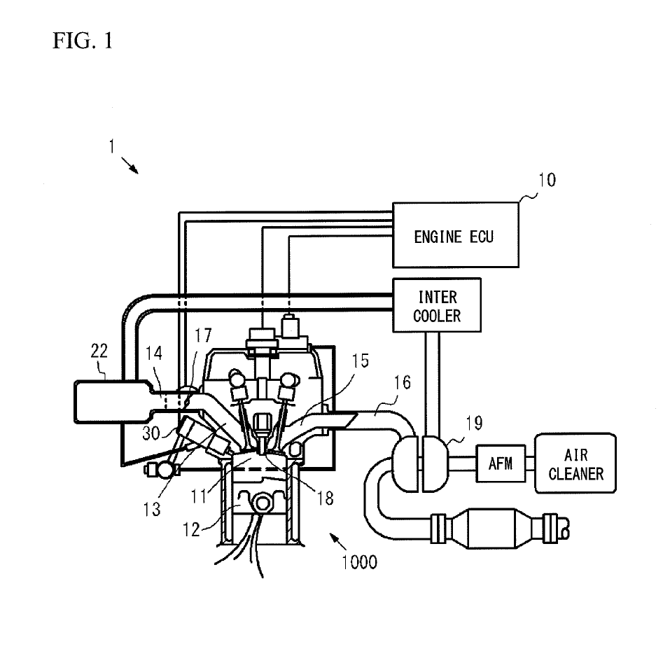

A first embodiment of the present invention is described with reference to the drawings. FIG. 1 is a view illustrating an example of a fuel injection device 1 equipped with a fuel injection valve 30. Here, FIG. 1 illustrates only a part of the structure of an engine 1000.

The fuel injection device 1 illustrated in FIG. 1 is equipped with the engine 1000 as a power source, and an engine ECU (Electronic Control Unit) 10 that comprehensively controls driving operation of the engine 1000. The fuel injection device 1 is equipped with the fuel injection valve 30 that injects a fuel into a combustion chamber 11 of the engine 1000. The engine ECU 10 has a function of a controller. The engine ECU 10 is a computer that includes a CPU (Central Processing Unit) performing an arithmetic process, a ROM (Read Only Memory) storing a program, and a RAM (Random Access Memory) and a NVRAM (Non Volatile RAM) storing data.

The engine 1000 is an engine to be equipped with a vehicle, and includes a piston 12 which constitutes the combustion chamber 11. The piston 12 is slidably fitted into a cylinder of the engine 1000. Then, the piston 12 is coupled with a crankshaft which is an output shaft member, via a connecting rod.

Intake air flowed into the combustion chamber 11 from an intake port 13 is compressed in the combustion chamber 11 by the upward movement of the piston 12. The engine ECU 10 decides fuel injection timing and transmits a signal to the fuel injection valve 30, based on information on a position of the piston 12 from a crank angle sensor and a rotary phase of a camshaft from a suction cam angle sensor. The fuel injection valve 30 injects the fuel at specified injection timing in response to the signal from the engine ECU 10. The fuel injected from the fuel injection valve 30 is atomized to be mixed with the compressed intake air. The fuel mixed with the intake air is ignited with a spark plug 18 to be burned, so that the combustion chamber 11 is expanded to move the piston 12 downwardly. The downward movement is changed to the rotation of the crankshaft via the connecting rod, so that the engine 1000 obtains power.

The combustion chamber 11 is connected to the intake port 13, and is connected to an intake path 14 which introduces the intake air to the combustion chamber 11 from the intake port 13 and which is connected to the intake port 13. Further, the combustion chamber 11 of each cylinder is connected to an exhaust port 15, and is connected to an exhaust path 16 which introduces an exhaust gas generated in the combustion chamber 11 to the outside of the engine 1000 is connected to the exhaust port 15. A surge tank 22 is arranged at the intake path 14.

An airflow meter, a throttle valve 17 and a throttle position sensor are installed in the intake path 14. The airflow meter and the throttle position sensor respectively detect a volume of the intake air passing through the intake path 14 and an opening degree of the throttle valve 17 to transmit the detection results to the engine ECU 10. The engine ECU 10 recognizes the volume of the intake air introduced to the intake port 13 and the combustion chamber 11 on the basis of the transmitted detection results, and adjusts the opening degree of the throttle valve 17 to adjust the volume of the intake air.

A turbocharger 19 is arranged at the exhaust path 16. The turbocharger 19 uses the kinetic energy of the exhaust gas passing through the exhaust path 16, thereby allowing a turbine to rotate. Therefore, the intake air that has passed through an air cleaner is compressed to flow into an intercooler. After the compressed intake air is cooled in the intercooler to be temporarily retained in the surge tank 22, it is introduced into the intake path 14. In this case, the engine 1000 is not limited to a supercharged engine provided with the turbocharger 19, and may be a normally aspirated (Natural Aspiration) engine.

The piston 12 is provided with a cavity at the top surface thereof. As for the cavity, the wall surface is formed by a curved surface which is gently continued from a direction of the fuel injection valve 30 to a direction of the spark plug 18, and the fuel injected from the fuel injection valve 30 is introduced to the vicinity of the spark plug 18 along the shape of the wall surface. In this case, the cavity of the piston 12 can be formed in an arbitrary shape at an arbitrary position in response to the specification of the engine 1000. For example, a re-entrant type combustion chamber may be provided in such a manner that a circular cavity is formed at the central portion of the top surface of the piston 12.

The fuel injection valve 30 is mounted in the combustion chamber 11 under the intake port 13. On the basis of an instruction from the engine ECU 10, the fuel injection valve 30 directly injects the high-pressured fuel supplied from a fuel pump via a fuel path into the combustion chamber 11 through an injection hole 33 provided at a front end portion of a nozzle body 31. The injected fuel is atomized and mixed with the intake air in the combustion chamber 11 to be introduced to the vicinity of the spark plug 18 along the shape of the cavity. The leak fuel of the fuel injection valve 30 is returned from a relief valve to a fuel tank through a relief pipe.

The fuel injection valve 30 is not limited to the arrangement under the intake port 13. The fuel injection valve 30 may be arranged at an arbitrary position in the combustion chamber 11. For example, the fuel injection valve 30 may be arranged such that the fuel is injected from a top center part of the combustion chamber 11.

Here, the engine 1000 may be any one of a gasoline engine using gasoline as the fuel, a diesel engine using a diesel oil as the fuel, and a flexible fuel engine using a fuel containing the gasoline and the diesel oil at an arbitrary ratio. In addition to this, the engine 1000 may be an engine using any fuel which can be injected by the fuel injection valve. A hybrid system may be established by the engine 1000 and plural electric motors combined therewith.

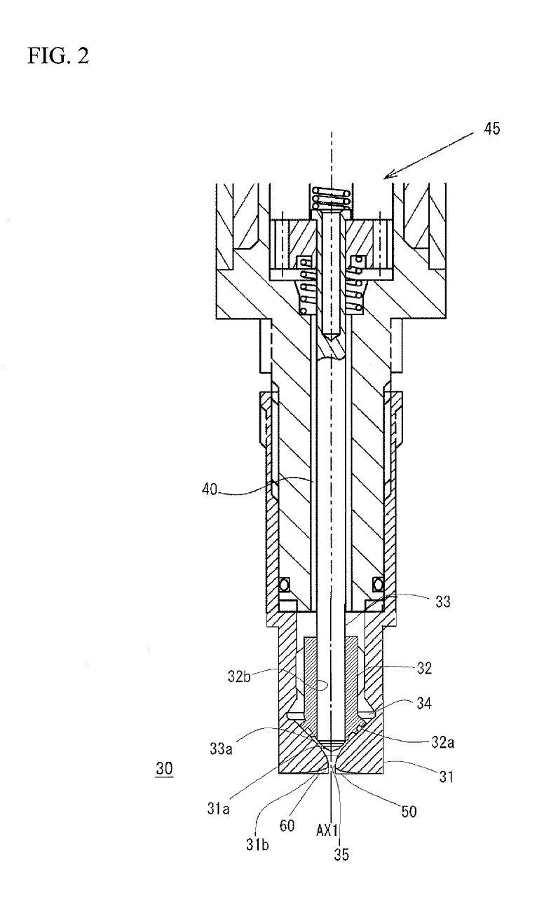

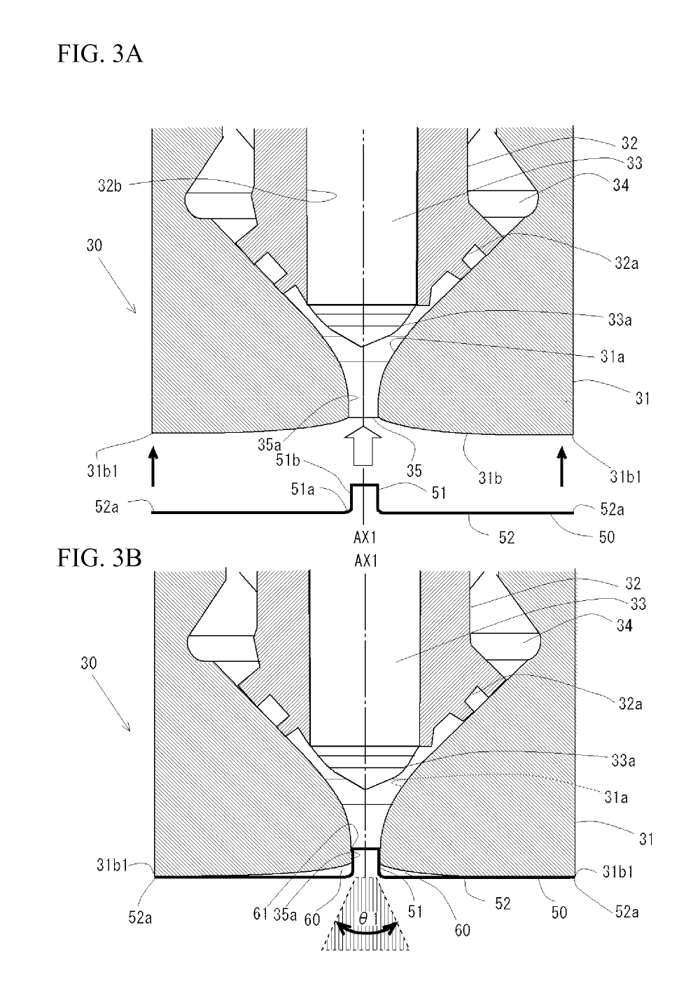

Next, a detailed description will be given of the structure of the fuel injection valve 30 according to an embodiment in the present invention. FIG. 2 is an explanatory view illustrating a cross section of a main portion of the fuel injection valve 30 according to the first embodiment. FIG. 3A is an explanatory view illustrating the state where an front end portion of the fuel injection valve 30 is attached with an injection-hole extending member 50. FIG. 3B is an explanatory view illustrating the front end portion of the fuel injection valve 30, according to the first embodiment, attached with the injection-hole extending member 50.

The fuel injection valve 30 includes the nozzle body 31, a needle guide 32, and a needle valve 33.

The nozzle body 31 is a tubular shaped member and has a seat surface 31a therewithin. A seat portion 33a of the needle valve 33, will be described later, sits on the seat surface 31a. A pressure chamber 34 is formed on the upstream side with respect to the seat surface 31a. Also, the nozzle body 31 is provided with the injection hole 35 at the downstream side with respect to the seat surface 31a. The axis AX1 of the injection hole 35 coincides with the axial of the nozzle body 31.

The needle guide 32 is installed within the nozzle body 31. The needle guide 32 is a tubular shaped member, and is provided with a spiral groove 32a at its front end portion. The spiral groove 32a corresponds to a swirl flow generating portion that causes the fuel introduced into the injection hole 35 and having been injected therefrom to swirl. That is, the fuel has been temporarily introduced into the pressure chamber 34 through a fuel path 40, formed between the inner circumferential wall of the nozzle body 31 and the outer circumferential surface of the rear end side of the needle guide 32, and then the fuel is introduced to the spiral groove 32a. The swirling component is given to the fuel in such a way, thereby generating the swirl flow.

The needle valve 33 is slidably arranged on an inner circumferential wall surface 32b of the needle guide 32. The needle valve 33 reciprocates in the direction of the axis AX1. The needle valve 33 is provided with the seat portion 33a at its front end side. This seat portion 33a sits on the seat surface 31a, so that the fuel injection valve 30 is brought into the closed state.

Referring to FIG. 2, the fuel injection valve 30 includes a driving mechanism 45. The driving mechanism 45 controls the sliding movement of the needle valve 33. The driving mechanism 45 is conventionally known, and is equipped with parts suitable for the movement of the needle valve 33, such as an actuator using a piezoelectric element and an electromagnet, and an elastic component which gives a suitable pressure to the needle valve 33.

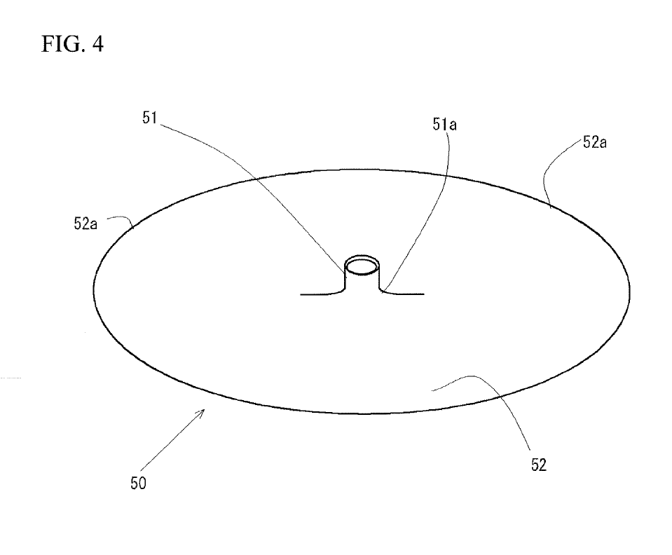

In the fuel injection valve 30, referring to FIGS. 3A and 3B, the injection-hole extending member 50 is provided at a front end portion 31b of the nozzle body 31. FIG. 4 is a perspective view of the injection-hole extending member 50. The injection-hole extending member 50 includes a movable portion 51 and a pressure receiving portion 52. The movable portion 51 has a tubular shape with its axis coinciding with the direction of the axis AX1 of the injection hole 35. The pressure receiving portion 52 is a plate shaped body that has a disk shape, that extends radially outward from a front edge 51a of the movable portion 51 in the direction, perpendicular to the axis AX1 of the injection hole 35, of the nozzle body 31, and that includes an outer circumferential edge portion 52a supported by the nozzle body 31. The outer circumferential edge portion 52a of the pressure receiving portion 52 is secured to and supported by an outer circumferential edge portion 31b1 of the front end portion 31b of the nozzle body 31 by welding. Therefore, a space 60 is formed between the pressure receiving portion 52 and the front end portion 31b of the nozzle body 31. The formation of the space 60 permits the pressure receiving portion 52 that is the plate-shaped body to be warped.

A clearance 61 is formed between an inner circumferential surface 35a of the injection hole 35 and an outer circumferential surface 51b of the movable portion 51 under atmospheric pressure. Thus, the formation of the clearance 61 under atmospheric pressure facilitates the production of the movable portion 51 in view of machining accuracy therefor. Further, this facilitates the attachment of the movable portion 51 to the injection hole 35. In addition, when the fuel is actually injected, the diameter of the movable portion 51 having a tubular shape is increased by the pressure within the cylinder, thereby suppressing the stepped difference within the injection hole 35.

A description will be given of the state of the fuel injection by the fuel injection valve 30 mentioned above. The fuel injection device 1 equipped with the fuel injection valve 30 adjusts the fuel injection pressure on the basis of a value, such as a cold water temperature of the engine 1000, indicating the engine warming up state. The fuel to be injected from the fuel injection valve 30 flows through the spiral groove 32a to swirl, so that the atomization of the fuel is promoted. The purpose of generating the swirling flow is to ensure good diffusion of the fuel or the atomization of the fuel. The principle of the atomization of the fuel is as follows. When the fast swirling flow generated within the fuel injection valve 30 is introduced into the injection hole 35, the negative pressure is generated in the swirling center of the strong swirling flow. When the negative pressure is generated, air outside the fuel injection valve 30 is sucked into the injection hole 35. This generates an air column in the injection hole 35. In the boundary between the fuel and the air column generated in such a way, fine bubbles are generated. The generated bubbles are mixed into the fuel flowing around the air column, and the flow mixed with the bubbles is injected together with the fuel flowing to the outer circumferential side. The bubbles are crushed to atomize the fuel.

The fuel injection device 1 adjusts the fuel injection pressure to control the atomization degree of the spray or the collapse time of the fine bubbles. It is thus possible to suppress the adhesion of the spray of droplets to the wall surface of the combustion chamber 11 in light of the driving state of the engine 1000, thereby suppressing oil dilution, PM (Particulate Matter), and smoke. It is also possible to form a homogeneous air-fuel mixture in the combustion chamber, thereby reducing HC (hydrocarbon) and CO (carbon monoxide). Furthermore, the suitable fuel pressure is ensured as not to wastefully increase the fuel pressure. This can improve the fuel efficiency without increasing the driving loss of the fuel pump.

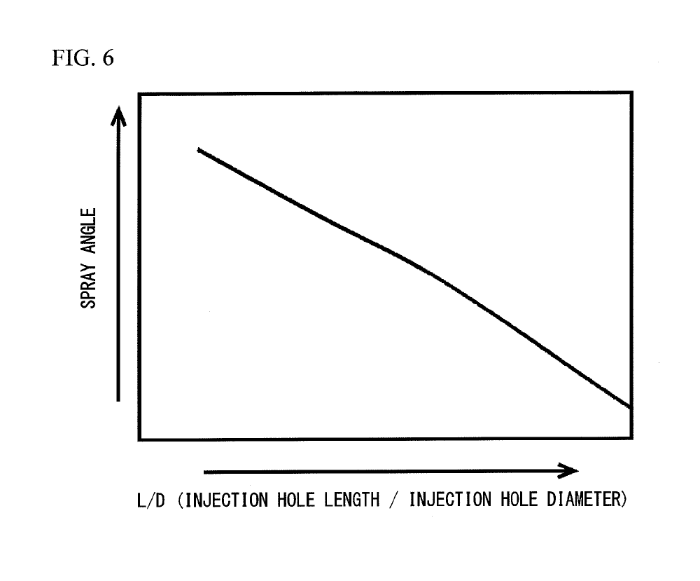

The injection-hole extending member 50 provided in the fuel injection valve 30 forms the space 60 under atmospheric pressure, as illustrated in FIG. 3B. In the state, the movable portion 51 protrudes from the injection hole 35, and the injection hole length is L1. When the injection hole length represents L1, the spray angle represents θ1. In contrast, in the state of the high pressure within the cylinder, the pressure receiving portion 52 provided in the injection-hole extending member 50 is warped by the high pressure within the cylinder. When the pressure receiving portion 52 is warped, the front end side of the pressure receiving portion 52 is bent to have a convex shape. The pressure receiving portion 52 pushes the movable portion 51 toward the back side (rear side) of the injection hole 35 while reducing the volume of the space 60. This results in that the injection hole length represents L2. When the injection hole length represents L2, the spray angle represents θ2. Herein, L1>L2 and θ1<θ2 are established. Referring to FIG. 6, there is a correlation between the spray angle and L/D (injection hole length/injection hole diameter). That is, when the value of L/D increases under the condition that the injection hole diameter is almost constant, the injection hole length increases. The injection hole length increases and the value of L/D increases, so the spray angle decreases. That is, the adjustment of the injection hole length allows the spray angle to be adjusted.

In the fuel injection valve 30 according to the first embodiment, the positions of the pressure receiving portion 52 and the movable portion 51 with respect to the injection hole 35 is changed in response to the pressure within the cylinder, thereby adjusting the injection hole length. The pressure receiving portion 52 is warped to store its elastic force.

Here, for example, in a case of performing the intake stroke injection, the piston is near BDC (bottom dead center) at the time of the fuel injection. In order to evenly spread the spray in the combustion chamber, and to obtain a uniform fuel-air mixture, it is desirable to reduce the spray angle. The pressure within the cylinder in the intake stroke is low, as compared with the compression stroke. In such a state, the pressure receiving portion 52 is not warped, and the movable portion 51 is maintained in the position of the front side of the injection hole 35. As a result, the injection hole length is long. When the injection hole length is long, the spray angle is small and the penetration is strong.

On the other hand, in a case of performing the compression stroke injection, from the viewpoint of avoiding the adhesion of the liquid fuel to the piston top surface, it is desirable to increase the spray angle. Specifically, in the case of forming the stratified air-fuel mixture by the compression stroke injection, or in the case of performing the diffusion combustion in a diesel engine, the piston is near TDC (top dead center) and is close to the fuel injection valve at the time of the fuel injection. Thus, in order not to adhere the liquid fuel to the piston, it is desirable to increase the spray angle. When the compression stroke injection is performed, the pressure within the cylinder increases. As a result, the movable portion 51 is pushed into the injection hole 35, and the injection hole length is short. Hence, the spray angle is increased. Thus, it is possible to conveniently increase the spray angle at the time of the compression stroke injection.

A description will be given of the function of the pressure receiving portion 52 for moving the movable portion 51 within the injection hole 35. The high pressure in the combustion chamber 11 causes the pressure receiving portion 52 to be warped, so that the movable portion 51 is pushed toward the upstream side of the injection hole 35. The pressure receiving portion 52 exerts the elastic force in the warped state. Therefore, when the pressure in the combustion chamber 11 is lower, the pressure receiving portion 52 returns to its original position by itself by the elastic force which the pressure receiving portion 52 exerts. In response to this, the movable portion 51 returns to its original position.

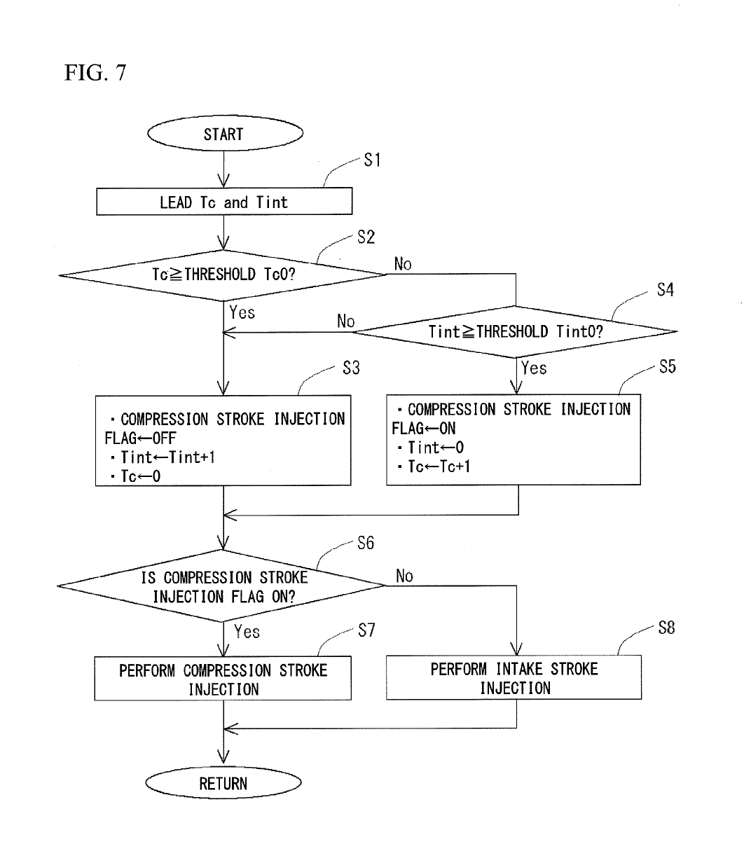

As described above, in the fuel injection valve 30, the position of the movable portion 51 with respect to the injection hole 35 is changed in response to the pressure within the cylinder, and the injection hole length is adjusted. Thus, the movable portion 51 can be moved within the injection hole 35. The fuel injection device 1 can remove deposits by use of the movement of the movable portion 51. The injection hole 35 is exposed to the combustion chamber at high temperature, so that the deposits accumulate in the injection hole 35 in some cases. The accumulation of deposits in the injection hole 35 might reduce the flow rate of the fuel through the injection hole 35 or might cause the spray fluctuation. Therefore, by actively performing the fuel injection in the state where the movable portion 51 is actuated, the deposits are removed. In the following, a description will be given of an example of the control to remove the deposits with reference to the flowchart of FIG. 7. This control is performed proactively by the ECU 10.

First, in step S1, Tc: the number of times of performing the compression stroke injection and Tint: the interval period from the end of the last compression stroke injection are read. These values are constantly updated as the fuel injection history and stored in the ECU 10.

In step S2, it is determined whether or not Tc is equal to or more than a threshold Tc0 beforehand set. Herein, the threshold Tc0 is set to ten. When Yes is determined in step S2, the process proceeds to step S3. In contrast, when No is determined in step S2, that is, when the compression stroke injection is not performed at a predetermined time for a predetermined period, the process proceeds to step S4. When Yes is determined in step S2, the compression stroke injection has been performed frequently. As for the compression stroke injection, the fuel is injected in the state where the movable portion 51 is actuated, so that the deposits are readily removed. To be more specific, the movable portion 51 is actuated in the compression stroke, so that it is easy to remove the deposits accumulated in the injection hole 35 and on the inner circumferential wall surface of the movable portion 51. The fuel is injected in such a state, thereby further facilitating the removal of deposits. Thus, in step S3, the compression stroke injection flag is set to OFF. In addition, Tint is counted up and is updated to Tint+1. Moreover, the value of Tc is cleared, and Tc=0 is set.

On the other hand, in step S4, it is determined whether or not Tint is equal to or more than the threshold Tint0 beforehand set. Herein, the threshold Tint0 is set to 30,000 cycles. 30,000 cycles correspond to the number of cycles at the time when the engine 1000 has been driven for 30 minutes at 2,000 rpm. When Yes is determined in step S4, the process proceeds to step S5. When No is determined in step S4, the process proceeds to step S3. When No is determined in step S4, the process proceeds to step S3. This is because the removal of deposits is not needed even when the compression stroke injection does not reach the threshold Tc0 (=ten times) and when 30,000 cycles are not achieved. In step S5, the compression stroke injection flag is set to ON. In addition, Tint is cleared, and Tint=0 is set. Moreover, Tc is counted up and is updated to Tc+1.

In step S6 subsequent to step S3 and S5, it is determined whether or not the compression stroke injection flag is ON. When Yes is determined in step S6, the process proceeds to step S7 and the compression stroke injection is performed. Therefore, the pressure receiving portion 52 is warped, and the fuel is injected in the state where the movable portion 51 is actuated, thereby facilitating the removal of deposits. In this case, the fuel injection amount per a cycle can be partly used for the compression stroke injection. For example, 80% of the intake stroke injection of the fuel injection amount required for the cycle may be used for the intake stroke injection, and the remaining 20% may be used for the compression stroke injection. When No is determined in step S6, the process proceeds to step S8 and the intake stroke injection is performed. When No is determined in step S6, the process proceeds to step S8 and the intake stroke injection is performed. After step S7 or S8, the processing is returned.

Further, even when the fuel is injected in other than the compression stroke, the pressure receiving portion 52 can be warped and the movable portion 51 can be actuated depending on the pressure within the cylinder, so that the effect of the peeling and removal of deposits is expected. However, the movable portion 51 is actively actuated in the above control, so that the deposits can be peeled off and removed. Further, the compression stroke injection changes the temperature around the injection hole, so that the effect of the cleaning and removal of deposits is further improved.

### Second Embodiment

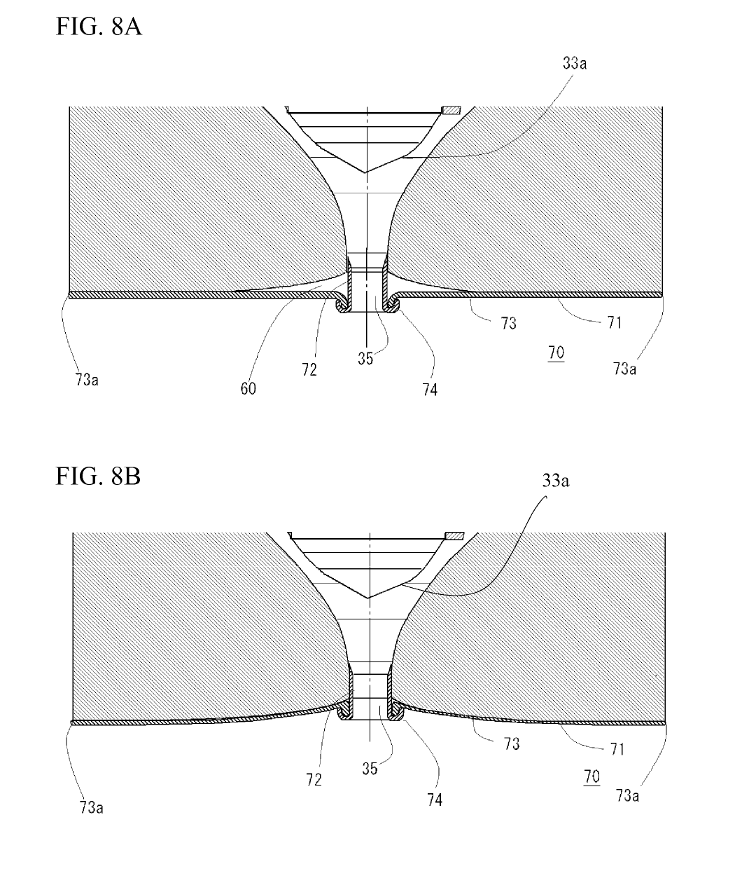

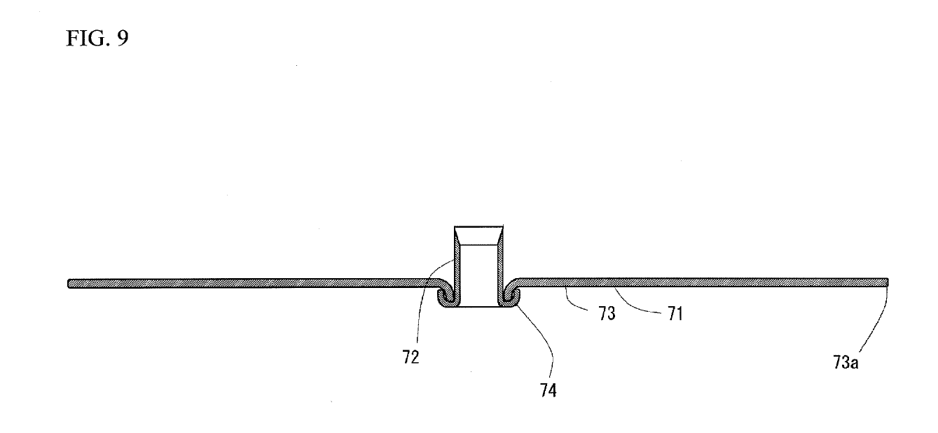

Next, a second embodiment will be described with reference to FIGS. 8 and 9. The second embodiment is different from the first embodiment in structure of the injection-hole extending member. That is, the second embodiment employs an injection-hole extending member 71 instead of the injection-hole extending member 50 employed in the first embodiment. The other components in the second embodiment are the same, common components are denoted by the same reference numerals in drawings, and a detailed description of such components will be omitted.

FIG. 8A is an explanatory view illustrating a front end portion of a fuel injection valve 70 according to the second embodiment. FIG. 8B is an explanatory view illustrating the state where the injection-hole extending member 71 is moved and the injection hole length is short. FIG. 9 is a cross section of the injection-hole extending member 71 provided in the fuel injection valve 70 according to the second embodiment.

The injection-hole extending member 71 is formed by combination of two pieces of a movable portion 72 and a pressure receiving portion 73 that are separately formed. The movable portion 72 has a tubular shape, and the edge portion of the front end side is folded and is caulked to the pressure receiving portion 73 having a disk shape, whereby the movable portion 72 is joined to the pressure receiving portion 73. Both are joined to each other in the continuous portion thereof by caulking in the above manner, so a projection portion 74 is formed in the front end portion of the movable portion 72. The projection portion 74 projects toward the piston 12 provided in the engine 1000.

The rigidity of the injection-hole extending member 71 is improved, since the movable portion 72 and the pressure receiving portion 73 are joined by caulking. This suppresses the deformation of the injection-hole extending member 71. Also, this can reduce the thickness of the injection-hole extending member 71. This can result in suppressing the stepped difference between the movable portion 72 and the injection hole 35. It is also possible to suppress the turbulence of the fuel flow within the injection hole 35, and to promote the generation of uniform fine bubbles by the strong swirling flow. Further, the formation of the projection portion 74 can suppress the Coanda effect in the opening edge portion of the injection hole 35. That is, if the opening edge of the injection hole 35 has a smooth curved shape (R shape), the Coanda effect might cause the spray to extend along a lower surface of the pressure receiving portion, so that the fuel fluctuation might be increased in the outer circumferential portion of the spray. Therefore, the provision of the projection portion 74 can suppress the Coanda effect to suppress the fuel fluctuation in the outer circumferential portion of the spray.

### Third Embodiment

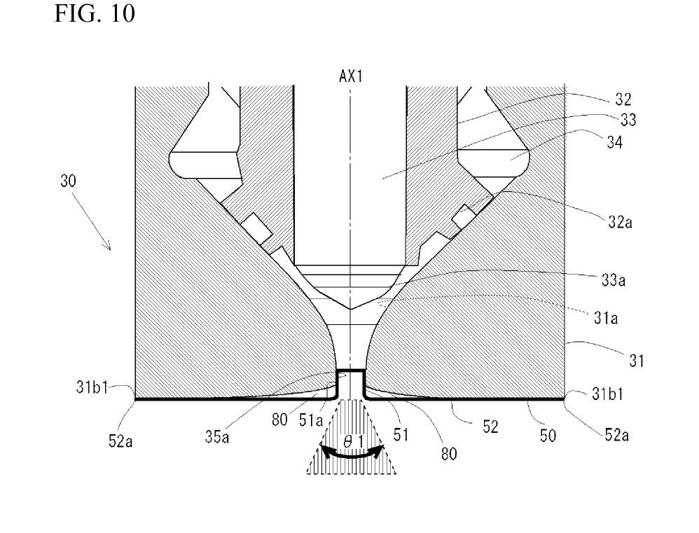

Next, a third embodiment will be described with reference to FIG. 10. In the third embodiment, the space 60 in the first embodiment is changed into a gas chamber 80. Specifically, the clearance between the inner circumferential surface 35a of the injection hole 35 and the outer circumferential surface 51b of the movable portion 51 in the third embodiment is narrower than in the first embodiment, and the space 60 in the first embodiment is separated from the outer space so as to function as the gas chamber 80. The gas chamber 80 functions as a damper, because airtightness of the space in which air exists is improved. The gas chamber 80 does not have to be in a vacuum state. In the third embodiment, air is filled within the gas chamber 80. A gas other than air may be filled within the gas chamber 80. Additionally, the other components are the same as those components in the first embodiment, common components are denoted by the same reference numerals in drawings, and a detailed description of such components will be omitted.

The operation of the injection-hole extending member 50 in the third embodiment is influenced not only by the elastic force of the pressure receiving portion 52 as described in the first embodiment but also by the pressure within the gas chamber 80. Specifically, in a state where the pressure within the cylinder is balanced with the pressure within the gas chamber 80 and the elastic force of the pressure receiving portion 52, the movable portion 51 is maintained and positioned in the front end side of the injection hole 35, and the injection hole length is long. When the injection hole length is long, the spray angle is small and the penetration is strong. When the pressure within the cylinder is higher than the pressure within the gas chamber 80 and the elastic force of the pressure receiving portion 52, the pressure receiving portion 52 is warped, so the movable portion 51 is pushed toward the upstream side of the injection hole 35. Thus, the injection hole length is short. When the pressure within the cylinder is low and the movable portion 51 and the pressure receiving portion 52 are returned to the respective original positions, the pressure within the gas chamber 80 and the elastic force due to the warp of the pressure receiving portion 52 exert on the pressure receiving portion 52, so that the movable portion 51 and the pressure receiving portion 52 are returned to the respective original positions.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the sprit and scope of the invention.

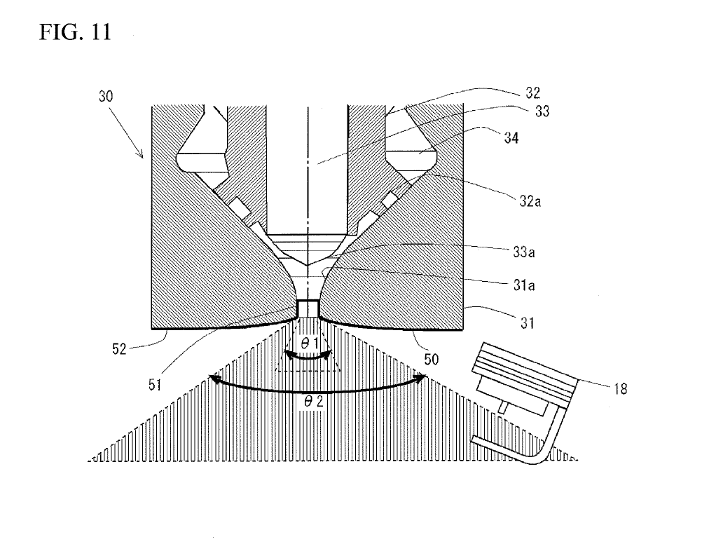

For example, as illustrated in FIG. 11, the position of the spark plug 18 can be set such that an ignition point is close to the profile of the spray with the maximum spray angle in the compression stroke. For example, as illustrated in FIG. 11, the spark plug 18 is arranged such that the ignition point is close to the profile of the spray with the spray angle θ2 in performing the compression stroke injection. Thus, only when the compression stroke injection is performed to form the stratified mixture, the spray is not close to the spark plug. It is thus possible to suppress the smoldering of the spark plug 18 that might be caused in performing stratified operation.

### DESCRIPTION OF LETTERS OR NUMERALS

1 fuel injection device
30, 70 fuel injection valve
31 nozzle body
31a seat surface
32 needle guide
32a spiral groove
33 needle valve
33a seat portion
35 injection hole
40 fuel path
50 injection-hole extending member
51 movable portion
52 pressure receiving portion
60 space
80 gas chamber
AX1 axis

1. A fuel injection valve comprising:
a needle valve including a seat portion in a front end side;
a nozzle body including a seat surface on which the seat portion sits, and including an injection hole at a downstream side with respect to the seat surface; and
an injection-hole extending member including:
a pressure receiving portion that receives pressure in a combustion chamber of an engine; and
a movable portion that moves in the injection hole in an axial direction of the injection hole in response to the pressure received by the pressure receiving portion, and that changes length of the injection hole.

2. The fuel injection valve of claim 1, wherein the pressure receiving portion forms a gas chamber between the pressure receiving portion and a front end portion of the nozzle body.

3. The fuel injection valve of claim 1, wherein
the movable portion has a tubular shape with an axis coinciding with the axial direction of the injection hole, and
the pressure receiving portion is a plate shaped body that extends radially outward from a front end of the movable portion in a direction, perpendicular to the axis of the injection hole, of the nozzle body, and that includes an outer circumferential edge portion supported by the nozzle body.

4. The fuel injection valve of claim 1, wherein a clearance is formed between an inner circumferential surface of the injection hole and an outer circumferential surface of the movable portion under atmospheric pressure.

5. The fuel injection valve of claim 1, comprising a projection portion provided in a continuous portion of the movable portion and the pressure receiving portion, and projects toward a piston provided in the engine.

6. The fuel injection valve of claim 1, comprising a swirl flow generating portion that causes fuel injected from the injection hole to swirl.

7. A fuel injection device comprising:
a fuel injection valve including:
a needle valve including a seat portion in a front end side;
a nozzle body including a seat surface on which the seat portion sits, and including an injection hole at a downstream side with respect to the seat surface; and
an injection-hole extending member including:
a pressure receiving portion that receives pressure in a combustion chamber of an engine; and
a movable portion that moves in the injection hole in an axial direction of the injection hole in response to the pressure received by the pressure receiving portion, and that changes length of the injection hole, and
a controller controls a timing of injecting fuel from the fuel injection valve,
wherein the controller controls the fuel injection valve to perform compression stroke injection, when the compression stroke injection is not performed at a predetermined time for a predetermined period on a basis of a fuel injection history.
